(19) United States
(12) Patent Application Publication
(10) Pub. No.: US 2024/0383196 A1
(43) Pub. Date: Nov. 21, 2024

(54) HIGHLY ALIGNED FIBER NOZZLE FOR ADDITIVE MANUFACTURING APPLICATIONS

(71) Applicant: UT-Battelle, LLC, Oak Ridge, TN (US)

(72) Inventors: Tyler C. Smith, Knoxville, TN (US); Ahmed A. Hassen, Knoxville, TN (US); John M. Lindahl, Powell, TN (US); Seokpum Kim, Knoxville, TN (US); Vlastimil Kunc, Knoxville, TN (US); Vipin Kumar, Knoxville, TN (US); Chase Joslin, Madisonville, TN (US)

(21) Appl. No.: 18/375,053

(22) Filed: Sep. 29, 2023

Related U.S. Application Data
(60) Provisional application No. 63/467,607, filed on May 19, 2023.
(60) Provisional application No. 63/467,606, filed on May 19, 2023.

(51) Int. Cl. B29C 64/209; B29C 64/165; B33Y 10/00; B33Y 30/00; B29K 105/14

(52) U.S. Cl. CPC B29C 64/209; B29C 64/165; B33Y 10/00; B33Y 30/00; B29K 2105/14

(57) ABSTRACT

An additive manufacturing system for an additive manufacturing material and embedded short-chopped fibers includes an extruder comprising a nozzle having a nozzle flow channel. The nozzle includes a plurality of spaced apart elongated aligning structures distributed inside the nozzle flow channel and parallel to the longitudinal center axis defining alignment flow channels within the nozzle flow channel. A nozzle for additive manufacturing, a method of additive manufacturing, and a method of making a nozzle for an additive manufacturing system for and additive manufacturing material and embedded short-chopped fibers are also disclosed.

### CROSS-REFERENCE TO RELATED APPLICATIONS

This application claims priority to U.S. Provisional Patent Application No. 63/467,606 filed May 19, 2023, titled “STATIC MIXING NOZZLES FOR LONG FIBER AND RESIN MIXING AND DISPERSING IN POLYMER ADDITIVE MANUFACTURING”, and U.S. Provisional Patent Application No. 63/467,607 filed May 19, 2023, titled “STATIC MIXING NOZZLES FOR FIBER RANDOMIZATION IN LARGE SCALE ADDITIVE MANUFACTURING APPLICATIONS”, the entire disclosures of which are incorporated herein by reference. This application is related to U.S. Utility patent application Ser. No. 18/375,019 entitled “Static Mixing Nozzles for Long Fiber and Resin Mixing and Dispersing in Polymer Additive Manufacturing”, and U.S. Utility patent application Ser. No. 18/375,085 for “Static Mixing Nozzles for Fiber Randomization in Large Scale Additive Manufacturing Applications”, both filed on even date herewith, the entire disclosures of which are hereby incorporated fully by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in this invention.

### FIELD OF THE INVENTION

The present invention relates generally to additive manufacturing, and more particularly to nozzles for extruders used in additive manufacturing with additive manufacturing materials incorporating fibers.

### BACKGROUND OF THE INVENTION

Static mixers are conventionally used to disperse multiple materials and mix them together to create hybrid mixtures. Mixers are also used as conventional practice in reactive polymer systems to mix hardeners with resin to allow for curing.

Conventional large scale additive manufacturing (AM) is conducted by melting thermoplastic polymers through a single screw extruder to produce a part in a layer-by-layer process. Non-filled polymers tend to have issues such as cracking, warping, and lower stiffness and lead to part failures. As such, short-chopped fibers are added to stiffen the material to prevent failure both during and after the print while also significantly increasing the mechanical stiffness and strength. During extrusion some of the fibers tend to align in the direction of the deposition from shear in the nozzle at the nozzle wall. The presence of highly aligned fibers along the extrusion direction is concentrated at the outer perimeters of the bead and forms a skin containing aligned fibers, while the core of the bead has random fiber orientation. The size of the skin and the core zones are highly dependent on the size of the nozzle.

Highly aligned fibers in the print direction result in the printed part exhibiting a low coefficient of linear thermal expansion (CLTE), high stiffness, high strength and thermal properties in the print direction while the other two directions experience lower mechanical properties with higher CLTE properties. CLTE is a critical material property that should be considered during the design phase for applications such as tooling, one of the most highlighted applications for large scale additive manufacturing technology. There are applications where high degrees of anisotropy are desired throughout the bead such as autoclave tooling, core shell structures, and bending applications.

### SUMMARY OF THE INVENTION

An additive manufacturing system for an additive manufacturing material and embedded short-chopped fibers includes an extruder including a nozzle having a nozzle flow channel defined by a channel wall. The nozzle flow channel has a longitudinal center axis, a diameter D_{FC}, and a length L_{FC}, an input end and an opposing output end. The nozzle flow channel can be fluidly coupled at the input end to feeding means through which additive manufacturing material and short-chopped fibers are to be provided to the extruder. The nozzle includes a plurality of spaced apart elongated aligning structures distributed inside the nozzle flow channel and parallel to the longitudinal center axis. The aligning structures have a length L_{AS}, a width W_{AS} and a thickness T_{AS}, and defining alignment flow channels within the nozzle flow channel.

The nozzle is configured to guide a bead of the additive manufacturing material and short-chopped fibers from the input end to the output end of the nozzle flow channel through the alignment flow channels, to align the orientations of the short-chopped fiber with the longitudinal axis center axis of the channel and create an aligned bead, and extrude the aligned bead through the output end. The aligned bead is deposited as part of a layer of an object being formed by the additive manufacturing system. The nozzle flow channel in one embodiment can be tubular.

The length of the aligning structures L_{AS} can be from 20% to 100% of the length L_{FC} of the nozzle flow channel. The width W_{AS} of the aligning structures can be from 10% to 100% of the flow channel diameter D_{FC}. The nozzle can have 2 to 100 alignment flow channels.

The aligning structures can be concentric tubes. The aligning structures can include parallel plates. The aligning structures can include conduits. Each conduit defines an alignment flow channel. The alignment flow channels can be parallel to each other. The conduits can be adjacent polygonal conduits. The conduits can be a plurality of adjacent tubes.

The bead can have a skin thickness T_{SK}. The alignment flow channels can have a lateral dimension of from 0.1 to 2.5 T_{SK}.

A method of additive manufacturing with an additive manufacturing material and embedded short-chopped fibers can include the step of providing an extruder comprising a nozzle having a nozzle flow channel defined by a channel wall. The nozzle flow channel has a longitudinal center axis, a diameter D_{FC}, and a length L_{FC}, an input end and an opposing output end. The nozzle flow channel can be fluidly coupled at the input end to feeding means through which additive manufacturing material and short-chopped fibers are to be provided to the extruder. The nozzle includes a plurality of spaced apart elongated aligning structures distributed inside the nozzle flow channel and parallel to the longitudinal center axis. The aligning structures have a length L_{AS}, a width W_{AS} and a thickness T_{AS}, and define alignment flow channels within the nozzle flow channel.

A bead of the additive manufacturing material and short-chopped fibers is guided from the input end to the output end of the nozzle flow channel through the alignment flow channels. This aligns the orientations of the short-chopped fiber with the longitudinal axis center axis of the channel and create an aligned bead. The aligned bead is extruded through the output end, causing the aligned bead to be deposited as part of a layer of an object being formed by the additive manufacturing system.

A method of making a nozzle for additive manufacturing with an additive manufacturing material and embedded short-chopped fibers includes the step of providing a test nozzle having a test flow channel having a diameter D_{TFC}. An additive manufacturing material and short-chopped fibers are flowed through the test flow channel of the test nozzle and an extruded bead of the additive manufacturing material and short-chopped fibers is drawn. The bead has a core of additive manufacturing material and randomized short-chopped fibers, and a skin comprising aligned short chop fibers. The thickness of the skin T_{SK} is measured.

An additive manufacturing nozzle is created having an additive manufacturing flow channel defined by a channel wall. The nozzle flow channel has a longitudinal center axis, a diameter D_{MFC}, and a length L_{MFC}, an input end and an opposing output end. The manufacturing nozzle flow channel is fluidly coupled at the input end to feeding means through which additive manufacturing material and short-chopped fibers are provided to the extruder. The additive manufacturing nozzle includes a plurality of spaced apart elongated aligning structures distributed inside the manufacturing nozzle flow channel and parallel to the longitudinal center axis. The aligning structures have a length L_{AS}, a width W_{AS} and a thickness T_{AS}, and defining alignment flow channels within the nozzle flow channel having a width W_{AFC}. A plurality of the aligning structures are distributed inside the flow channel, parallel to the longitudinal center axis. The nozzle flow channel width W_{AFC} is from 0.1 to 2.5 T_{SK}.

A nozzle for additive manufacturing with an additive manufacturing material and embedded short-chopped fibers includes a nozzle flow channel defined by a channel wall. The nozzle flow channel has a longitudinal center axis, a diameter D_{FC} and a length L_{FC}, an input end and an opposing output end. The nozzle includes a plurality of spaced apart elongated aligning structures distributed inside the nozzle flow channel and parallel to the longitudinal center axis. The aligning structures have a length L_{AS}, a width W_{AS} and a thickness T_{AS}, and defining alignment flow channels within the nozzle flow channel.

### BRIEF DESCRIPTION OF THE DRAWINGS

There are shown in the drawings embodiments that are presently being understood that the invention is not limited to the arrangements and instrumentalities shown, wherein:

FIG. 1 is a perspective view of a highly aligned fiber nozzle.

FIG. 2 is a side elevation.

FIG. 3 is a cross section taken along line 3-3 in FIG. 2.

FIG. 4 is an expanded view of area FIG. 4 in FIG. 3.

FIG. 5 is an expanded view of area FIG. 5 in FIG. 3.

FIG. 6 is a perspective view of the cross-section of FIG. 3.

FIG. 7 is a top plan view.

FIG. 8 is a bottom view.

FIG. 9 is a cross-section of a highly aligned fiber nozzle in operation.

FIG. 10 is an expanded area FIG. 10 in FIG. 9.

FIG. 11 is a top perspective view of an alternative embodiment.

FIG. 12 is a bottom perspective view of the alternative embodiment of FIG. 11.

FIG. 13 is a side elevation of the alternative embodiment of FIG. 11.

FIG. 14 is a cross-section taken along line 14-14 in FIG. 13.

FIG. 15 is a bottom perspective view of the cross-section of FIG. 14.

FIG. 16 is an expanded view of area FIG. 16 in FIG. 14.

FIG. 17 is an expanded view of area FIG. 17 in FIG. 14.

FIG. 18 a top plan view of another alternative embodiment.

FIG. 19 is a side elevation of the alternative embodiment of FIG. 18.

FIG. 20 is a cross section taken along line 20-20 in FIG. 18.

FIG. 21 is a cross section taken along line 21-21 in FIG. 19.

FIG. 22 is a top perspective view of the cross-section of FIG. 21.

FIG. 23 is an expanded view of area FIG. 23 in FIG. 22.

FIG. 24 is a perspective view of a cross-section of another alternative embodiment.

FIG. 25 is a cross section illustrating operation of a test nozzle.

FIG. 26 is a schematic depiction of an extruder system.

### DETAILED DESCRIPTION OF THE INVENTION

An additive manufacturing system for an additive manufacturing material and embedded short-chopped fibers includes an extruder comprising a nozzle having a nozzle flow channel defined by a channel wall. The nozzle flow channel has a longitudinal center axis A_{FC}, a diameter D_{FC}, and a length L_{FC}, an input end and an opposing output end. The nozzle flow channel is fluidly coupled at the input end to feeding means through which additive manufacturing material and short-chopped fibers are to be provided to the extruder. The nozzle comprises a plurality of spaced apart elongated aligning structures distributed inside the nozzle flow channel and parallel to the longitudinal center axis. The aligning structures having a length L_{AS}, a width W_{AS} and a thickness T_{AS}, and define alignment flow channels within the nozzle flow channel.

The nozzle is configured to guide a bead of the additive manufacturing material and short-chopped fibers from the input end to the output end of the nozzle flow channel through the alignment flow channels. The passage through the alignment flow channels aligns the orientations of the short-chopped fiber with the longitudinal axis center axis of the channel and creates an aligned bead. The aligned bead is extruded through the output end of the nozzle, causing the aligned bead to be deposited as part of a layer of an object being formed by the additive manufacturing system.

The nozzle can have different shapes. The nozzle flow channel can be tubular. The nozzle can have other shapes, for example oval, or a geometrical shape such as square, triangular or hexagonal.

The length of the aligning structures L_{AS} can vary. The length of the aligning structures L_{AS} can be from 20% to 100% of the length L_{FC} of the nozzle flow channel. The length of the aligning structures L_{AS} can be 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% of the length L_{FC} of the nozzle flow channel, and can be within a range of any high value and low value selected from these values.

The fibers suitable for use with this invention can vary. Some of these fibers can consist of short-chopped carbon fiber, glass fiber, bio-fibers, basalt fibers, or high aspect ratio particulates. These fibers can range in length from 1-500 um and a diameter of 1-200 um.

The width W_{AS} of the aligning structures is from 10% to 100% of the flow channel diameter D_{FC}. The width of the aligning structures can be 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% of the flow channel diameter D_{FC}, and can be within a range of any high value and low value selected from these values.

The number of alignment flow channels can vary. The number of alignment flow channels can be 2-100 alignment flow channels. The number of alignment flow channels can be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100, and can be within a range of any high value and low value selected from these values.

The aligning structures can take a variety of different shapes. The aligning structures can be concentric tubes. The aligning structures can be parallel plates. The aligning structures can comprise conduits, where each conduit defines an alignment flow channel, and the alignment flow channels are parallel to each other. The conduits can include adjacent polygonal conduits. The conduits can include a plurality of adjacent tubes.

The bead can have a skin thickness T_{SK}. The alignment flow channels can have a width or lateral dimension of from 0.1 to 2.5 T_{SK}. The alignment flow channels can have a lateral dimension of 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2, 2, 2.3, 2.4, or 2.5 T_{SK}, and can have a lateral dimension within a range of any high value and low value selected from these values.

A method of additive manufacturing with an additive manufacturing material and embedded short-chopped fibers can include the step of providing an extruder comprising a nozzle having a nozzle flow channel defined by a channel wall. The nozzle flow channel has a longitudinal center axis A_{FC}, a diameter D_{FC}, and a length L_{FC}, an input end and an opposing output end. The nozzle flow channel is fluidly coupled at the input end to feeding means through which additive manufacturing material and short-chopped fibers are to be provided to the extruder. The nozzle includes a plurality of spaced apart elongated aligning structures distributed inside the nozzle flow channel and parallel to the longitudinal center axis. The aligning structures have a length L_{AS}, a width W_{AS} and a thickness T_{AS}, and define alignment flow channels within the nozzle flow channel.

A bead of the additive manufacturing material and short-chopped fibers is guided from the input end to the output end of the nozzle flow channel through the alignment flow channels, to align the orientations of the short-chopped fiber with the longitudinal axis center axis of the channel and create an aligned bead. The aligned bead is extruded through the output end, causing the aligned bead to be deposited as part of a layer of an object being formed by the additive manufacturing system.

A method of making a nozzle for additive manufacturing with an additive manufacturing material and embedded short-chopped fibers can include the step of providing a test nozzle having a test flow channel having a diameter D_{TFC}. An additive manufacturing material and short-chopped fibers are flowed through the test flow channel of the test nozzle. An extruded bead of the additive manufacturing material and short-chopped fibers is drawn, where the bead has a core of additive manufacturing material and randomized short-chopped fibers, and a skin comprising aligned short chop fibers. A thickness of the skin T_{SK} is measured.

An additive manufacturing nozzle having an additive manufacturing flow channel defined by a channel wall is created. The nozzle flow channel has a longitudinal center axis, a diameter D_{MFC}, a circumference C_{MFC}, and a length L_{MFC}, an input end and an opposing output end. The manufacturing nozzle flow channel is fluidly coupled at the input end to feeding means through which additive manufacturing material and short-chopped fibers are to be provided to the extruder. The additive manufacturing nozzle includes a plurality of spaced apart elongated aligning structures distributed inside the manufacturing nozzle flow channel and parallel to the longitudinal center axis. The aligning structures have a length L_{AS}, a width W_{AS} and a thickness T_{AS}, and defining alignment flow channels within the nozzle flow channel having a width W_{AFC}, with a plurality of the aligning structures distributed inside the flow channel, parallel to the longitudinal center axis. W_{AFC} is in the range of from 0.1 to 2.5 T_{SK}.

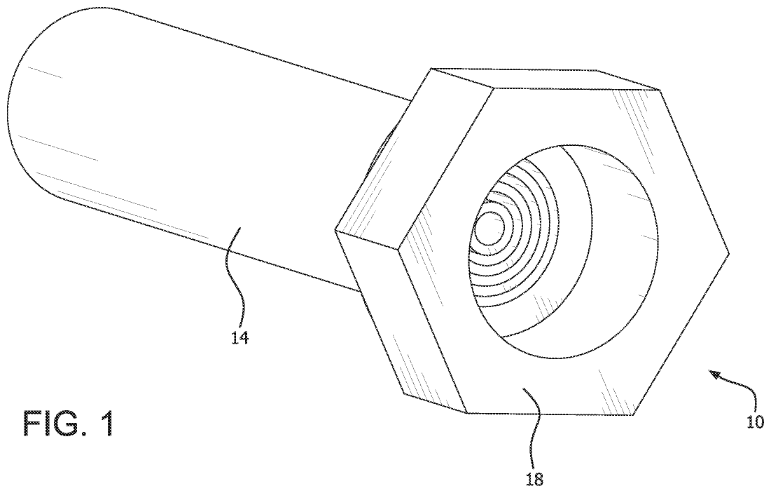

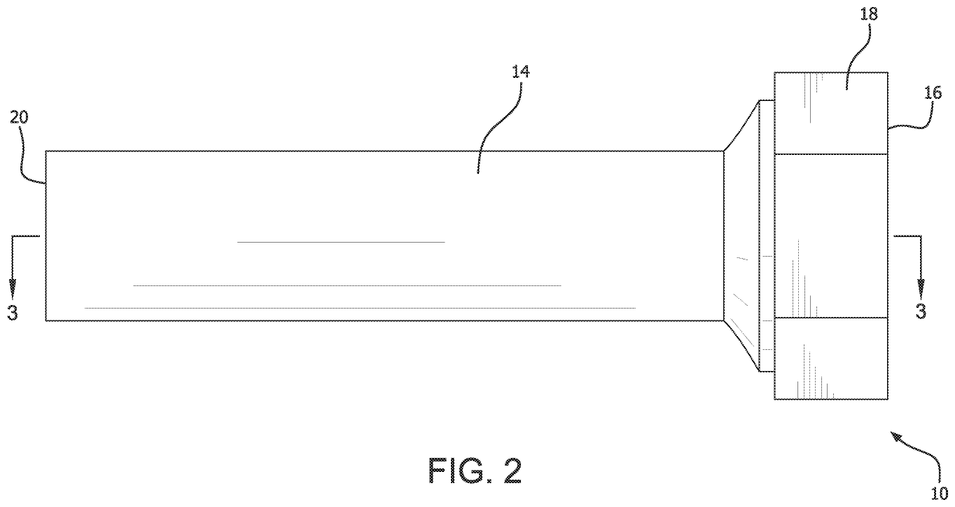

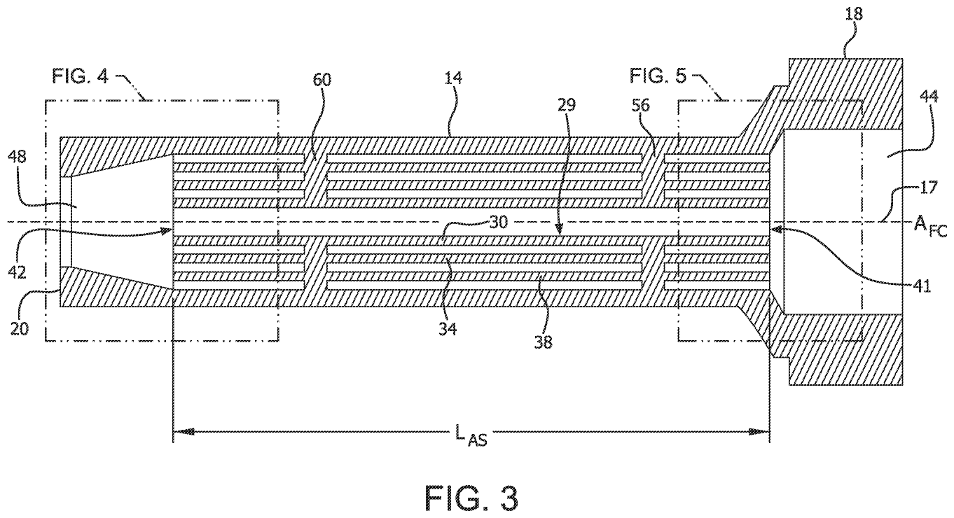

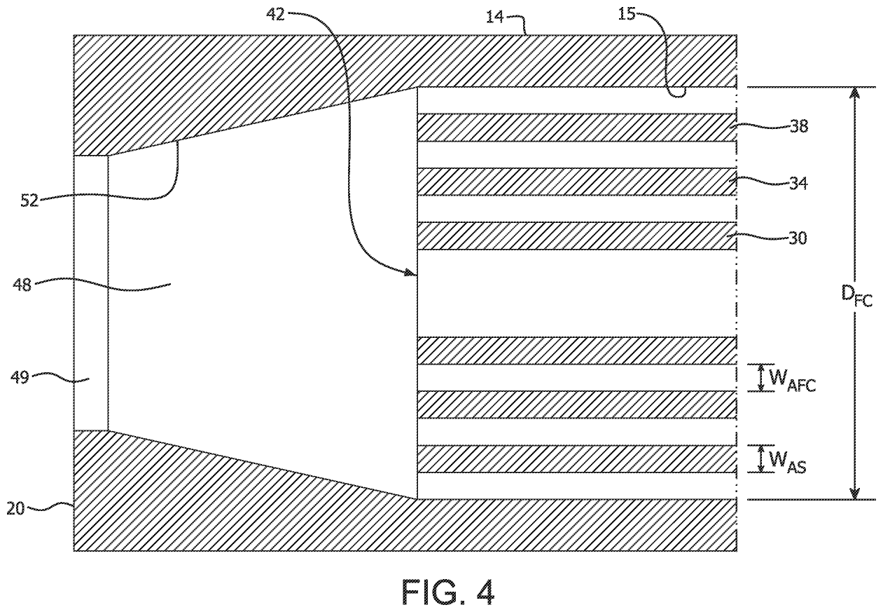

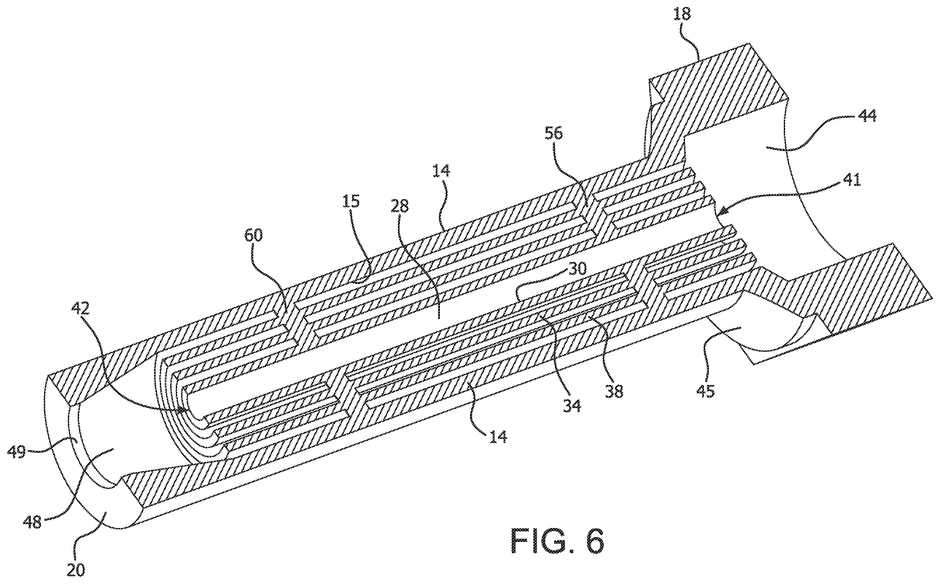

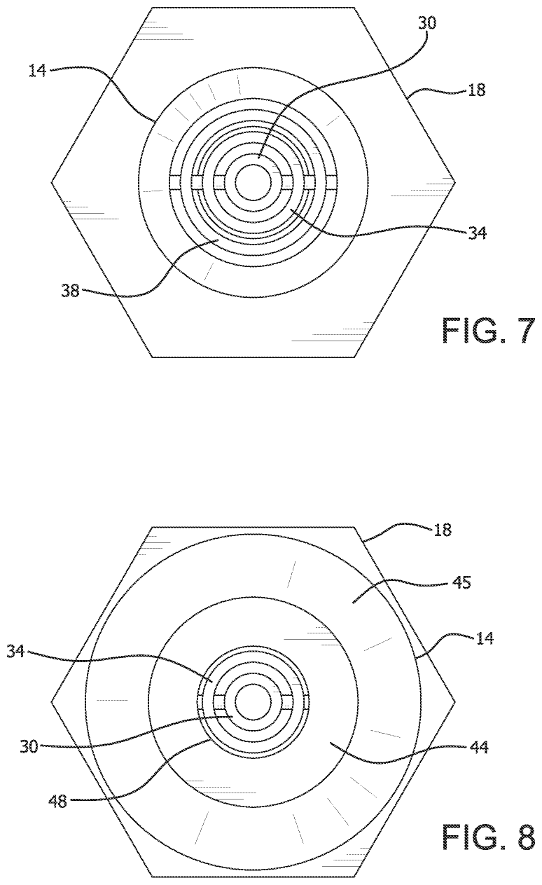

There is shown in FIGS. 1-8 nozzle 10 according to the invention. The nozzle 10 includes a nozzle body 14 with a distal end 16 and a nozzle head 18 that is attached to a proximal end 16 of the nozzle body 14. The head 18 is designed to connect the nozzle 10 to other parts of the extruder assembly and can be of any suitable size and design. The nozzle body 14 has an interior wall 15 and defines an open interior flow channel 29 with a flow channel inlet 41 and a flow channel outlet 42, a diameter D_{FC} and a long axis A_{FC} 15. Within the flow channel 29 are a plurality of concentric alignment flow tubes about the long axis A_{FC} 17 comprising innermost alignment flow tube 30, middle alignment flow tube 34, and laterally outermost alignment flow tube 38. More or fewer alignment flow tubes are possible.

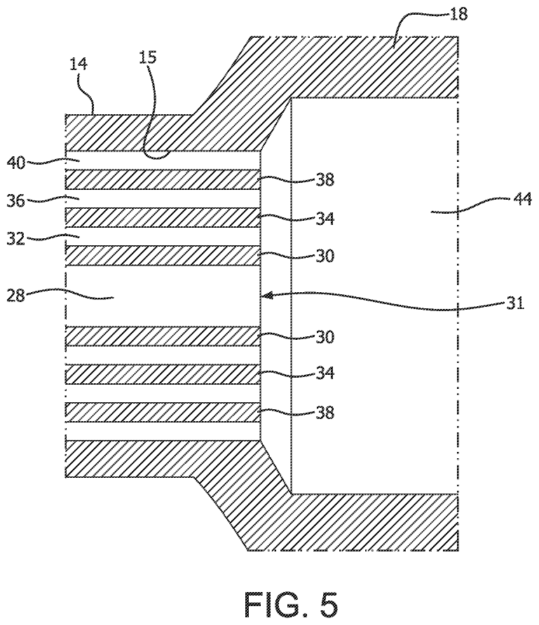

The concentric alignment flow tubes define open interior spaces which serve as alignment flow channels. The innermost flow tube 30 defines a tubular alignment flow channel 28 (FIG. 5). The middle flow tube 34 together with the innermost flow tube 30 defines an annular alignment flow channel 32. The outermost flow tube 38 and the middle flow tube 34 define an annular alignment flow channel 36. The nozzle body 14 and the outermost flow tube 38 define still another alignment flow channel 40. The alignment flow tubes can be secured within the flow channel 29 by any suitable means, such as supporting brackets 56 and 60. Other supporting structure is possible.

The dimensions of the concentric alignment flow tubes and respective alignment flow channels can vary. The width or thickness of the alignment flow tubes W_{AS} and the width or thickness of the respective alignment flow channels W_{AFC} are selected to provide an aligning flow shear during the flow of the additive manufacturing material and the short-chopped fibers through the alignment flow channels. The shear force acts to straighten and align the short-chopped fibers in the direction of flow, parallel to the axis A_{FC}.

The head 18 can be adapted to connect the nozzle 10 to the extruder system and therefore can have differing sizes and shapes. The nozzle body 14 can have a compression zone 48 with conical side walls 52 to apply pressure to the additive manufacturing material as it progresses through the nozzle body 14 to an additive material exit opening 49 at the distal end 20. The head 18 can have an additive material inlet 44 and a neck portion 45 such that the additive material inlet 44 communicates with the flow channel 29 and the additive material exit opening 49 at a distal end of the nozzle body 14.

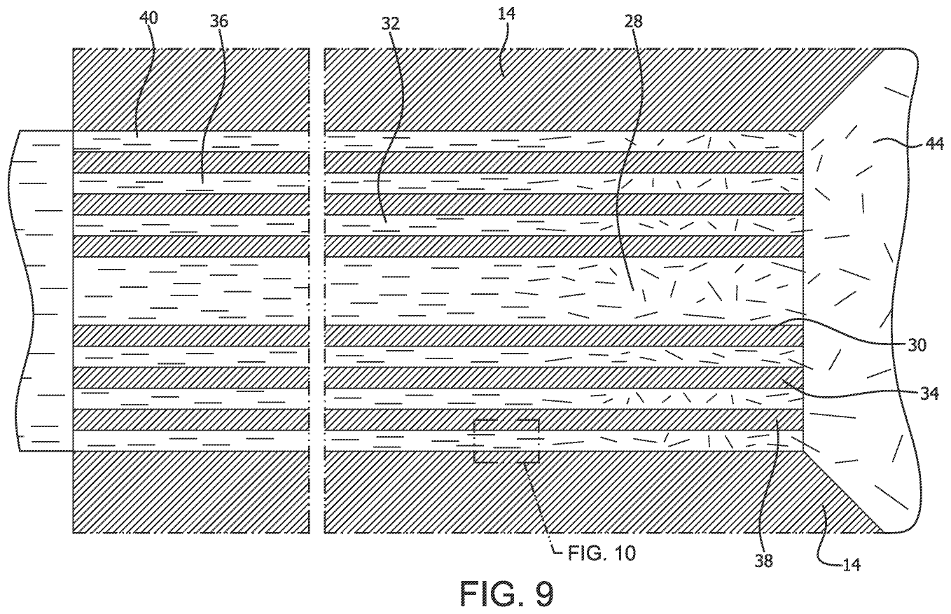

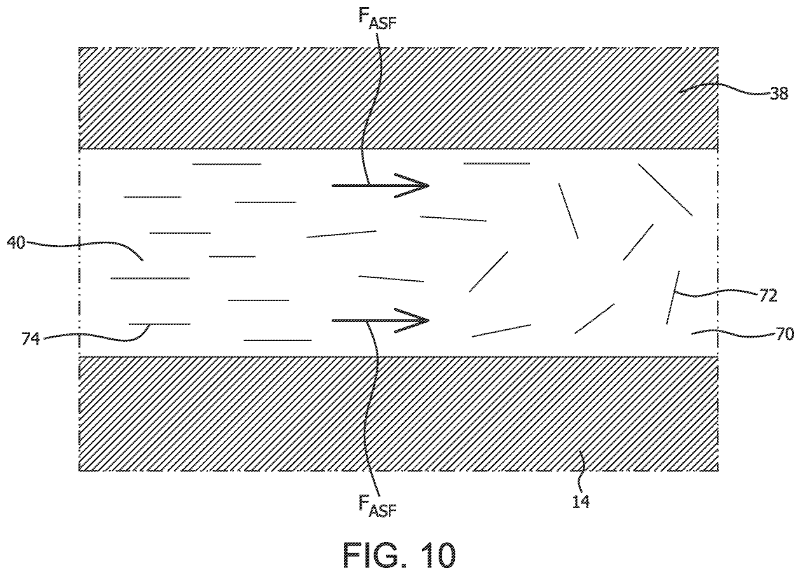

Additive material and short-chopped fibers flow into the additive material inlet 44 of the head 18 and flow into the alignment flow channels 28, 32, 36 and 40. As shown in FIGS. 9-10, the flow of material through the alignment flow channels such as alignment flow channel 40 creates a shear force F_{ASF} due to contact between the additive manufacturing material 70 with randomly oriented short-chopped fibers 72 and the walls of alignment flow tube 38 and the nozzle body 14. This shear force F_{ASF} acts to align the short-chopped fibers 72 as they progress through the alignment flow channel 40. The width of the alignment flow channels W_{AFC} is selected such that the aligning shear force F_{ASF} acts upon all of the randomly oriented fibers 72 within the alignment flow channels. The shear force F_{ASF} that is necessary to properly align the short-chopped fibers will depend on a variety of factors such as the additive material that is used, the material and dimensions of the short-chopped fibers, and the wall material and surface roughness of the alignment flow channels. These dimensions are determined empirically through the use of differing dimension and analysis of the orientation of the short-chopped fibers, or through testing as will be described.

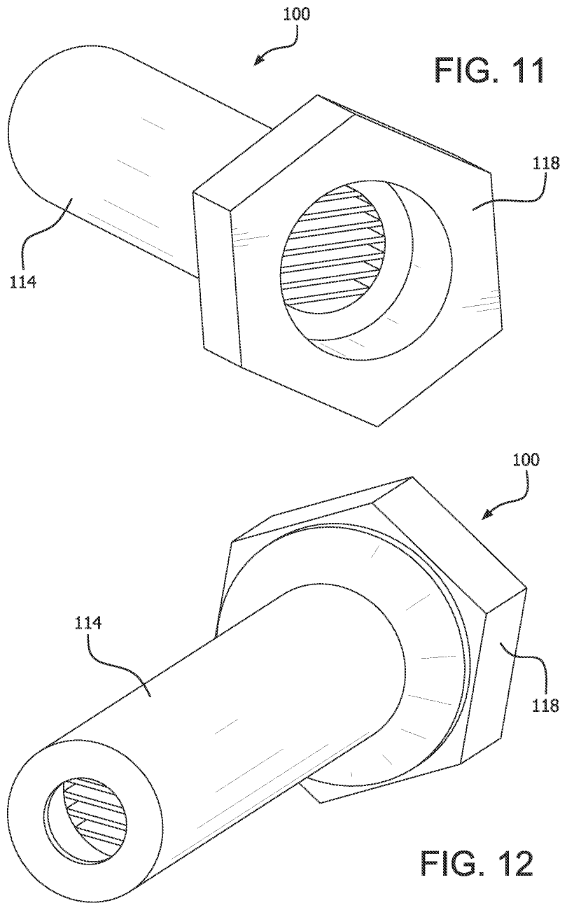

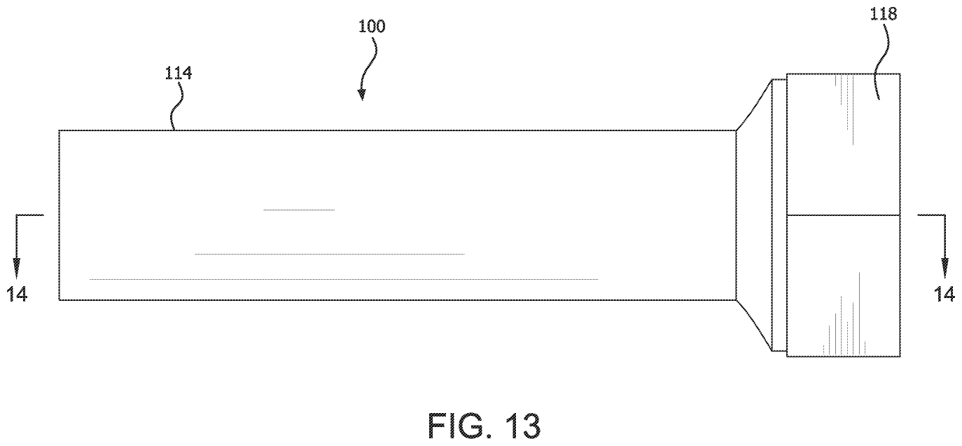

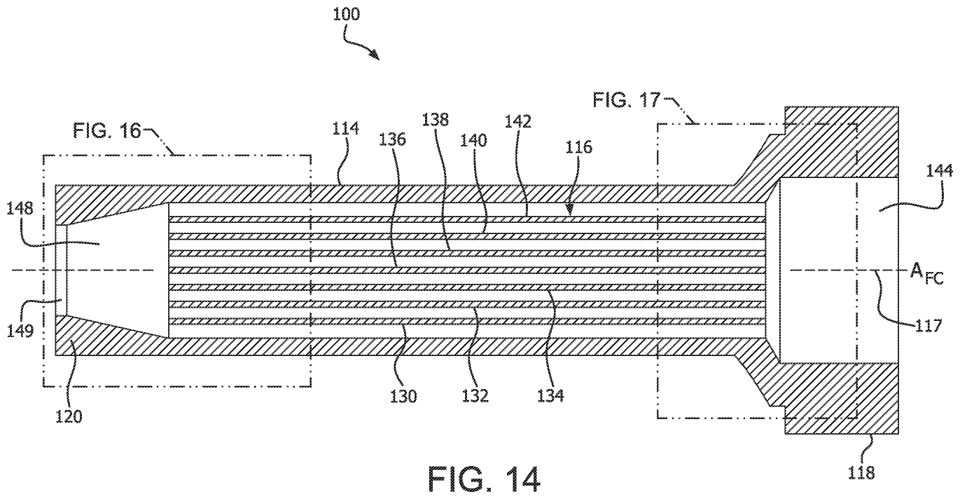

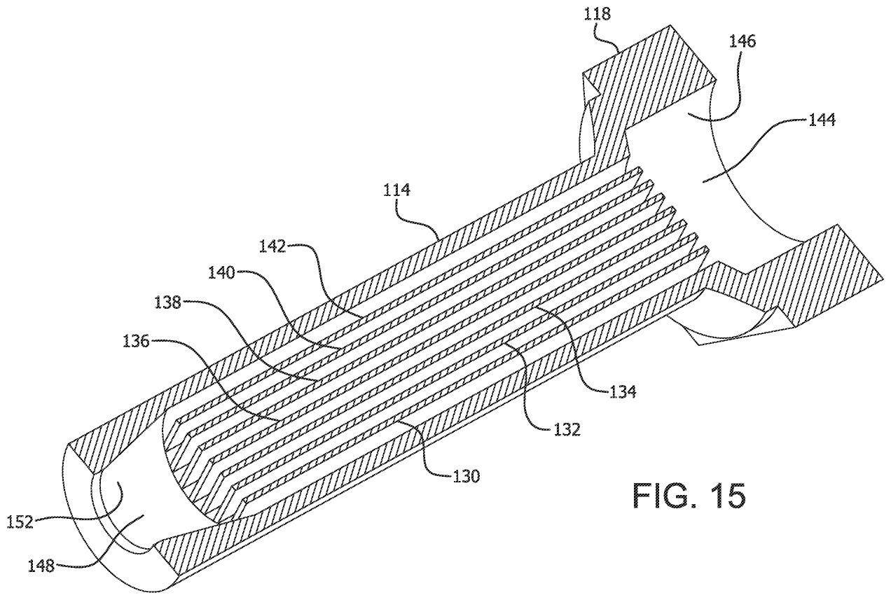

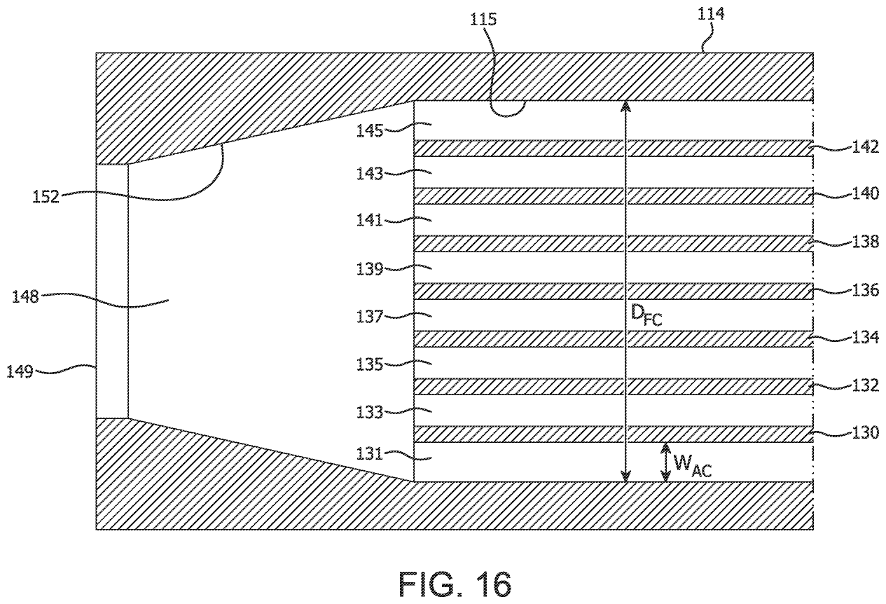

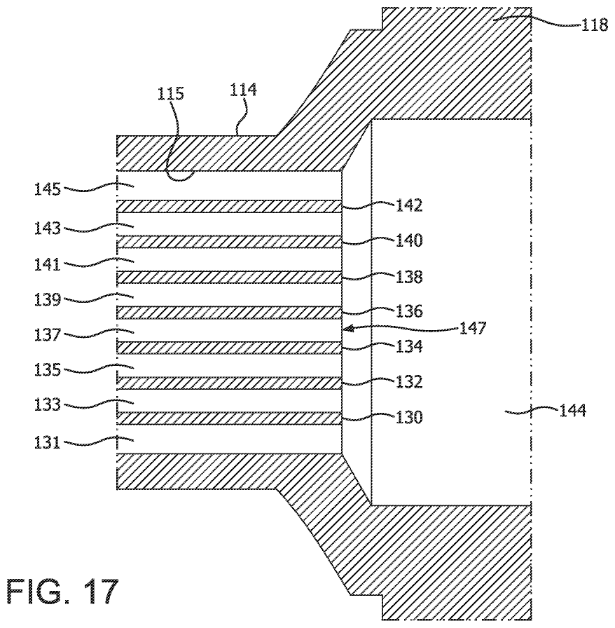

Alignment flow channels with differing geometries are possible, so long as the alignment flow channels create the aligning shear force throughout the flowing additive manufacturing material with short-chopped fibers to properly align the randomly oriented short-chopped fibers into aligned short-chopped fibers. One such alternative geometry is shown in FIGS. 11-17. A nozzle 100 includes a nozzle body 114 having a flow channel 116 and a nozzle head 118. A plurality of flow aligning plates are disposed within the flow channel 116, and are connected at lateral sides to an interior wall 115 of the nozzle body 114. The flow aligning plates are parallel to each other and to a long axis A_{FC} 117 of the flow channel 116. Any number of plates are possible, and the number of plates can depend on the necessary size of the flow channel 116 having a diameter D_{FC} for the desired flow rate of additive material and short-chopped fibers, together with the necessary plate spacing W_{AFC} to impart the necessary shear force at the walls of the plates to align the short-chopped fibers within the additive manufacturing material. The additive manufacturing nozzle 100 has plates 130, 132, 134, 136, 138, 140, and 142, however, more or fewer plates are possible. The plates define flow channels 131, 133, 135, 137, 139, 141, 143, and 145. The additive manufacturing material and short-chopped fibers flow from an inlet 144 in the head 118, through opening 144 defined by wall 146 and flow channel inlet 147, through the flow channel 116 to a compression zone 148 defined by conical wall 152 to an additive material exit opening 149 in a distal end 120 of the nozzle body 114.

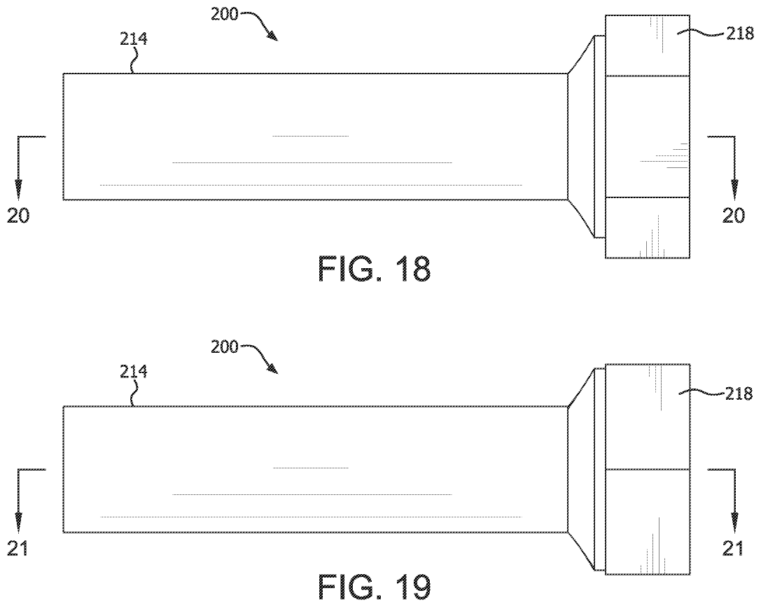

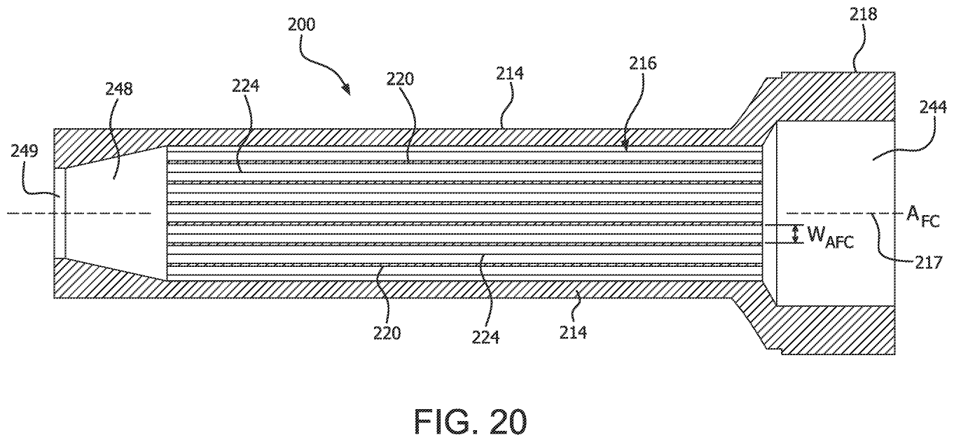

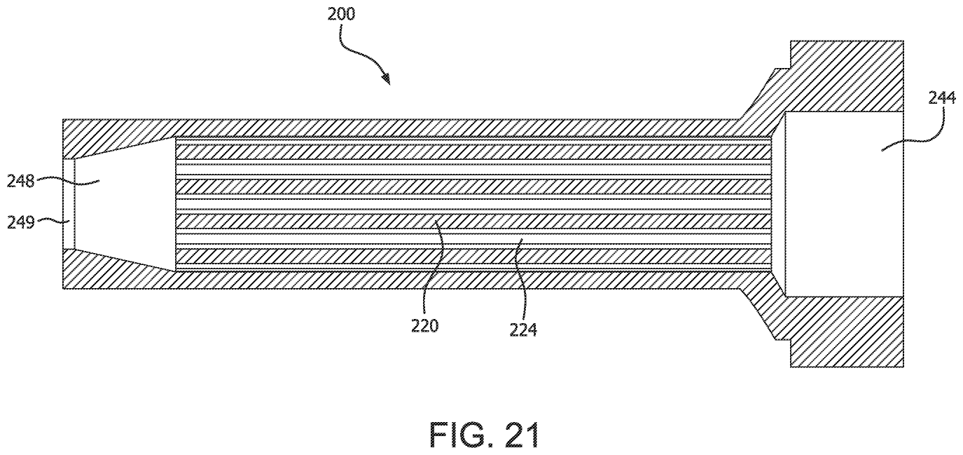

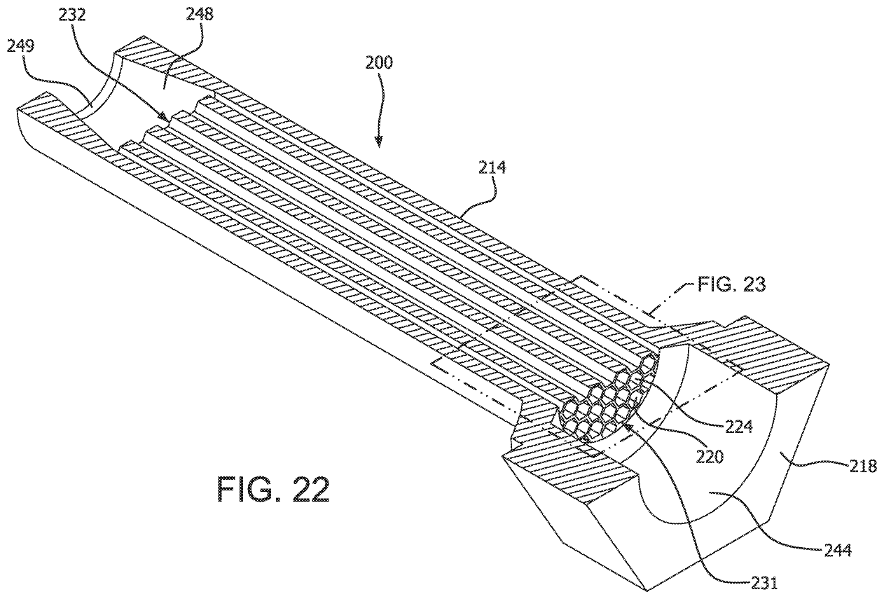

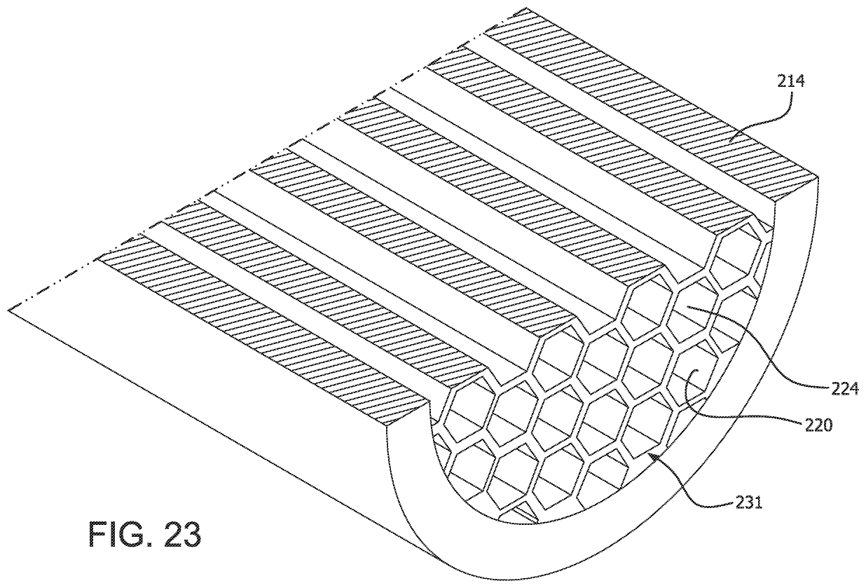

Hexagonal flow channels are shown in FIGS. 18-23 in an additive manufacturing nozzle 200. The nozzle 200 has a nozzle body 214 and a nozzle head 218. The nozzle body 214 defines an open interior flow channel 216. A plurality of hexagonal alignment flow structures or conduits 220 are provided in the flow channel 216. The hexagonal alignment flow conduits 220 define a plurality of parallel hexagonal alignment flow channels 224 that are parallel to the axis A_{FC} of the flow channel 216. Additive manufacturing material and short-chopped fibers enter through additive manufacturing material inlet 244 in the head 218, flows through the inlet 231 of the flow channel 216, through the hexagonal alignment flow channels 224 and the flow channel outlet 232 and through the compression zone 248 to the additive manufacturing material exit 249. The width of the hexagonal alignment flow channels 224 W_{AFC} is selected such that additive manufacturing material and the short-chopped fibers are subjected to a sufficient shear force that the short-chopped fibers are aligned within the additive manufacturing material.

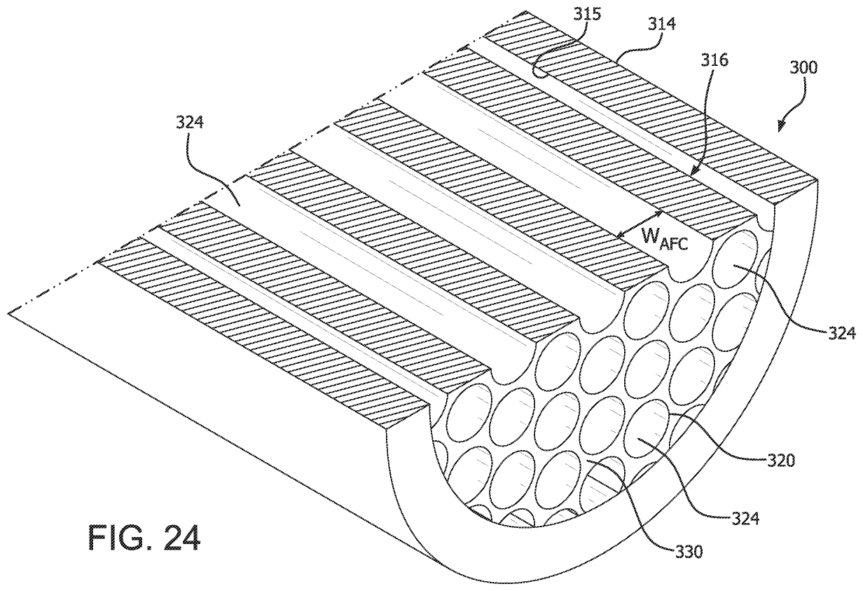

Parallel and adjacent tubular alignment flow channels are shown in FIG. 24 for an additive manufacturing nozzle 300. The nozzle 300 has a nozzle body 314 with an interior wall 315 defining a flow channel 316. A plurality of parallel flow alignment tubes 320 can be provided and define a plurality of flow alignment channels 324. The flow alignment tubes 320 can be fashioned from a monolithic tube matrix material 330 that is secured within the flow channel 316. The width of the tubular alignment flow channels 324 W_{AFC} is selected such that additive manufacturing material and the short-chopped fibers are subjected to a sufficient shear force that the short-chopped fibers are aligned within the additive manufacturing material as the additive manufacturing material and short-chopped fibers low through the flow alignment channels 324 of the flow alignment tubes 320.

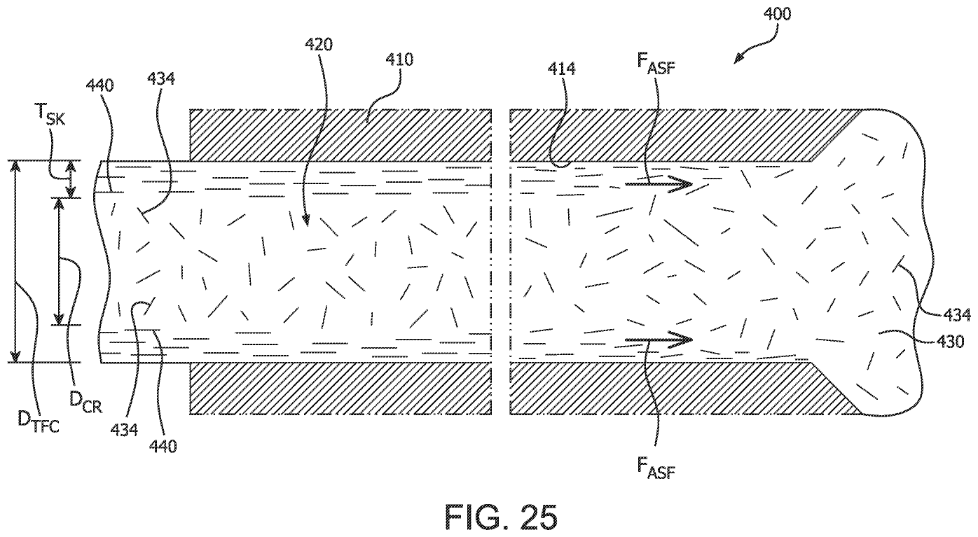

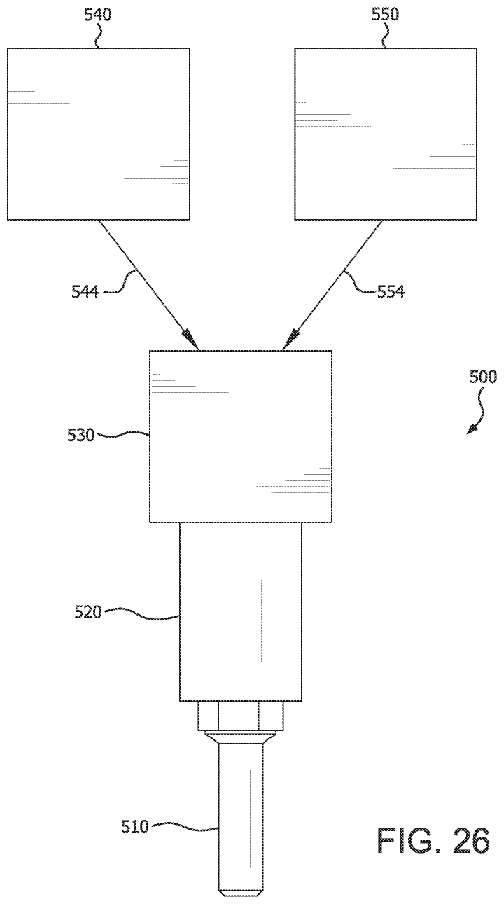

The width of the flow alignment channels must be small enough to subject the additive manufacturing material and short-chopped fibers flowing through the channels to a sufficient shear force that is imparted by the walls forming the channels such that the short-chopped fibers are aligned as the flow progresses through the channels. The channels should not be unduly narrow, however, as this will impede the flow of the additive manufacturing material through the nozzle. The proper dimensions can be determined empirically. There is shown in FIG. 25 a method of testing for an appropriate alignment flow channel width. A test nozzle 400 with a nozzle body 410 having an interior wall 414 defines an open interior test flow channel 420 having a diameter D_{TFC}. Additive manufacturing material 430 with randomly orient short-chopped fibers 434 is flowed through the test flow channel 420. The additive manufacturing material 430 and randomly oriented short-chopped fibers 434 encounter an alignment shear force indicated by arrow F_{ASF} due to interactions at the interior wall 414. The alignment shear force causes randomly oriented fibers near the interior wall 414 to align into aligned fibers 440. The aligning of fibers will be limited to some distance from the interior wall 414 which can be referred to as a skin having a thickness T_{SK}. A core of the flowing additive manufacturing material 430 and randomly oriented fibers 434 is distanced from the interior wall 414 and is therefore not impacted sufficiently to align the fibers, and so this region having a diameter D_{CR} has randomly oriented fibers 434. The extruded sample is analyzed and the thickness of the skin T_{SK} is determined. The alignment flow channels are given a width based upon this skin thickness T_{SK}, for example from 0.1 to 2.5 T_{SK}.

The nozzle of the invention can be used with a variety of different extruder systems for additive manufacturing with short-chopped fibers. A generalized depiction of an extruder system 500 is show in FIG. 26. The extruder system 500 includes a nozzle 510, a barrel 520 and a mixing manifold 530. A source of additive manufacturing material 540 provides additive manufacturing material though connection 544 to the mixing manifold 530. A source of short-chopped fibers 550 provides short-chopped fiber through a connection 554 to the mixing manifold 530. Other components of additive manufacturing are well known in the art.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. An additive manufacturing system for an additive manufacturing material and embedded short-chopped fibers, comprising:
an extruder comprising a nozzle having a nozzle flow channel defined by a channel wall, the nozzle flow channel having a longitudinal center axis, a diameter D_{FC}, and a length L_{FC}, an input end and an opposing output end, the nozzle flow channel being fluidly coupled at the input end to feeding means through which additive manufacturing material and short-chopped fibers are to be provided to the extruder, the nozzle comprising a plurality of spaced apart elongated aligning structures distributed inside the nozzle flow channel and parallel to the longitudinal center axis, the aligning structures having a length L_{AS}, a width W_{AS} and a thickness T_{AS}, and defining alignment flow channels within the nozzle flow channel;
wherein the nozzle is configured to guide a bead of the additive manufacturing material and short-chopped fibers from the input end to the output end of the nozzle flow channel through the alignment flow channels, to align the orientations of the short-chopped fiber with the longitudinal axis center axis of the channel and create an aligned bead, and extrude the aligned bead through the output end, causing the aligned bead to be deposited as part of a layer of an object being formed by the additive manufacturing system.

2. The system of claim 1, wherein the nozzle flow channel is tubular.

3. The system of claim 1, wherein the length of the aligning structures L_{AS} is from 20% to 100% of the length L_{FC} of the nozzle flow channel.

4. The system of claim 1, wherein the width W_{AS} of the aligning structures is from 10% to 100% of the flow channel diameter D_{FC}.

5. The system of claim 1, wherein the nozzle comprises 2-100 alignment flow channels.

6. The system of claim 1, wherein the aligning structures are concentric tubes.

7. The system of claim 1, wherein the aligning structures comprise parallel plates.

8. The system of claim 1, wherein the aligning structures comprise conduits, each conduit defining an alignment flow channel, the alignment flow channels being parallel to each other.

9. The system of claim 7, wherein the conduits comprise adjacent polygonal conduits.

10. The system of claim 7, wherein the conduits comprise a plurality of adjacent tubes.

11. The system of claim 1, where the bead has a skin thickness T_{SK}, and the alignment flow channels have a lateral dimension of from 0.1 to 2.5 T_{SK}.

12. A method of additive manufacturing with an additive manufacturing material and embedded short-chopped fibers, comprising the steps of:
providing an extruder comprising a nozzle having a nozzle flow channel defined by a channel wall, the nozzle flow channel having a longitudinal center axis, a diameter D_{FC}, and a length L_{FC}, an input end and an opposing output end, the nozzle flow channel being fluidly coupled at the input end to feeding means through which additive manufacturing material and short-chopped fibers are to be provided to the extruder, the nozzle comprising a plurality of spaced apart elongated aligning structures distributed inside the nozzle flow channel and parallel to the longitudinal center axis, the aligning structures having a length L_{AS}, a width W_{AS} and a thickness T_{AS}, and defining alignment flow channels within the nozzle flow channel;
guiding a bead of the additive manufacturing material and short-chopped fibers from the input end to the output end of the nozzle flow channel through the alignment flow channels, to align the orientations of the short-chopped fiber with the longitudinal axis center axis of the channel and create an aligned bead; and,
extruding the aligned bead through the output end, causing the aligned bead to be deposited as part of a layer of an object being formed by the additive manufacturing system.

13. A method of making a nozzle for additive manufacturing with an additive manufacturing material and embedded short-chopped fibers, the method comprising the steps of:
providing a test nozzle having a test flow channel having a diameter D_{TFC};
flowing an additive manufacturing material and short-chopped fibers through the test flow channel of the test nozzle and drawing an extruded bead of the additive manufacturing material and short-chopped fibers, the bead having a core of additive manufacturing material and randomized short-chopped fibers, and a skin comprising aligned short chop fibers;
measuring a thickness of the skin T_{SK}; and,
creating an additive manufacturing nozzle having an additive manufacturing flow channel defined by a channel wall, the nozzle flow channel having a longitudinal center axis, a diameter D_{MFC}, and a length L_{MFC}, an input end and an opposing output end, the manufacturing nozzle flow channel being fluidly coupled at the input end to feeding means through which additive manufacturing material and short-chopped fibers are to be provided to the extruder, the additive manufacturing nozzle comprising a plurality of spaced apart elongated aligning structures distributed inside the manufacturing nozzle flow channel and parallel to the longitudinal center axis, the aligning structures having a length L_{AS}, a width W_{AS} and a thickness T_{AS}, and defining alignment flow channels within the nozzle flow channel having a width W_{AFC}, with a plurality of the aligning structures distributed inside the flow channel, parallel to the longitudinal center axis, wherein W_{AFC} is from 0.1 to 2.5 T_{SK}.

14. A nozzle for additive manufacturing with an additive manufacturing material and embedded short-chopped fibers, comprising a nozzle flow channel defined by a channel wall, the nozzle flow channel having a longitudinal center axis, a diameter D_{FC}, and a length L_{FC}, an input end and an opposing output end, the nozzle comprising a plurality of spaced apart elongated aligning structures distributed inside the nozzle flow channel and parallel to the longitudinal center axis, the aligning structures having a length L_{AS}, a width W_{AS} and a thickness T_{AS}, and defining alignment flow channels within the nozzle flow channel.
